(19) United States
(12) Patent Application Publication
(10) Pub. No.: US 2026/0204969 A1
(43) Pub. Date: Jul. 16, 2026

(54) HIGH-EFFICIENCY AND HIGH-PERFORMANCE STATOR ASSEMBLY FOR A MOTOR

(71) Applicant: FENG-TIEN CHEN, TAICHUNG CITY (TW)

(72) Inventor: FENG-TIEN CHEN, TAICHUNG CITY (TW)

(21) Appl. No.: 19/025,098

(22) Filed: Jan. 16, 2025

(51) Int. Cl. H02K 3/28; H02K 3/12

(52) U.S. Cl. CPC H02K 3/28; H02K 3/12

(57) ABSTRACT

A motor's stator assembly includes a stator core and a winding unit with two windings. The first winding, made of a rectangular or square cross-section conductor, connects directly to the power source and provides a first rated output power. The second winding, made of a circular cross-section conductor, provides a second rated output power equal to or less than the first rated output power, and connects to the power source via a switching unit. During startup, the switch unit closes to combine the output powers of both windings. Once the motor reaches a set speed, the switch unit opens, connecting only the first winding to the power source to operate at its rated power.

### FIELD

The disclosure relates to motors, and particularly to a stator assembly for a motor.

### BACKGROUND

U.S. Patent No. 11,936,258B2 discloses a stator winding design for a motor. The stator winding includes a winding group comprising a primary winding with a first rated power and a secondary winding with a second rated power. This configuration allows users to adjust the motor's operation based on the required output power, either by supplying power to both windings simultaneously or by disconnecting power to one of the windings. As depicted in FIG. 1 and FIG. 8 of the patent, both the primary and secondary windings are housed within the same stator slot and have circular cross-sections. However, the inventor has identified several shortcomings in this design, including:

1. Uneven magnetic flux distribution.

2. Reduced efficiency.

3. Mechanical and thermal stress.

4. Increased vibration and noise.

Moreover, US Patent No. 7,759,834B2 discloses an electromagnetic device adopting conductor stacks made of copper in a rectangular sectional shape. This type of conductor with a rectangular cross-section can address the shortcomings of the previously mentioned conductor with a circular cross-section, but it still has certain disadvantages. For example, rectangular conductors may have the following drawbacks:

1. The manufacturing and embedding processes are more complex compared to circular conductors, requiring more precise machining and assembly techniques.

2. The internal conductors may experience uneven heat dissipation due to the stacking method.

### SUMMARY

At present, motor technology experts have not identified any technical solutions to fully address the aforementioned deficiencies. The core of this invention lies in the inventor's discovery that circular conductors are inefficient for filling rectangular stator slots. The gaps between circular conductors and slot walls lead to inefficient material utilization. Furthermore, circular conductors tend to cause uneven flux paths, reducing efficiency and performance. Limited contact between circular conductors and the stator core impairs heat transfer efficiency, potentially leading to overheating during high-load or prolonged operation. This overheating may shorten the motor's lifespan. Additionally, circular conductors can generate uneven electromagnetic forces within the stator slots, causing vibration and noise. While rectangular conductors can mitigate most of the deficiencies of circular conductors, they still present several challenges:

1. Achieving Precise Fit: Rectangular conductors must closely match the shape and dimensions of the stator slots. Failure to do so may result in improper fitting or gaps.

2. Edge Shaping: Precise shaping of rectangular conductor edges is essential.

3. Densely Packed Coils: Rectangular wires must be densely and evenly packed into the stator slots, which demands exceptional precision during manufacturing. Inadequate precision can lead to poor heat dissipation and uneven magnetic field distribution.

4. Challenging Insertion: Inserting rectangular conductors requires careful alignment of the edges and the application of uniform pressure, making the process considerably more complex compared to using circular conductors.

Moreover, the inventor has discovered that most motors currently on the market are typically equipped with only one set of stator windings. These motors predominantly employ conductors with circular or rectangular cross-sections. However, the inherent limitations of both conductor types remain unavoidable. Furthermore, the inventor observed that conventional motors consume substantially more energy during the startup phase than during normal operation. As a result, their designs must accommodate the elevated energy demands of startup, ultimately compromising overall energy efficiency.Therefore, designing a motor that consumes higher energy only during the startup phase while maintaining energy consumption aligned with the load during normal operation is of critical importance.

Thus, in one aspect of the present disclosure, the aforementioned deficiencies are mitigated by utilizing an improved stator assembly. The stator assembly comprises a stator core and a stator winding unit installed therein to generate kinetic energy in cooperation with a rotor of a motor. The stator winding unit comprises a first winding and a second winding. The first winding is used to deliver the output power during the motor's normal operation. The second winding is used together with the first winding to provide the output power required for motor startup. The first winding includes a first electrical conductor with a rectangular or square cross-section and a first rated output power under given conditions. The second winding includes a second electrical conductor with a circular cross-section and a second rated output power equal to or smaller than the first rated output power under the same given conditions. During operation, a first switching unit can be used to simultaneously connect the first winding and the second winding to a power source during motor startup, thereby combining their rated output powers as the motor's total output. Once the motor reaches normal operating conditions, the first switching unit disconnects the second winding from the power source, allowing the motor to operate at the first rated output power of the first winding.

The stator winding unit described in this disclosure can be applied to the main winding and/or the auxiliary/start winding of single-phase motors, as well as to the phase windings of polyphase motors.

In specific embodiments of the present disclosure, the first rated output power of the first winding equals the rated output power of the motor.

In specific embodiments of the present disclosure, the stator core includes a plurality of slots, each with a closed bottom and an open top. Each slot is divided into a first portion located near the closed bottom and a second portion situated near the open top. The first winding is installed in the first portion of the slot, while the second winding is installed in the second portion. Reserving space in the second portion of the slot during the embedding of the first winding enhances the filling factor within the slot. Furthermore, this arrangement facilitates the embedding process for rectangular conductors, reducing associated difficulties. Additionally, this arrangement simplifies the embedding of rectangular conductors. The second winding, confined to the second portion of the slot, primarily provides startup torque. This design effectively mitigates the limitations of circular conductors.

In another aspect of the present disclosure, the stator assembly may further include an electrical control unit to execute the aforementioned operational procedure. For instance, the electrical control unit has an input terminal connected to the power source and an output terminal that splits into a first branch connected to the first winding and a second branch connected to the second winding via the first switching unit.

In specific embodiments, the stator assembly may incorporate an inverter to regulate the operation of the first winding, enhancing motor efficiency and performance. Specifically, the stator assembly includes an inverter, a second switching unit, and a third switching unit. The second switching unit is positioned between the first winding and the power source, while the inverter's input end is connected to the third switching unit, and its output end is connected to the first winding. During the motor's startup phase, the first and second switching units are closed, and the third switching unit remains open, connecting both the first and second windings to the power source. This configuration combines the rated output powers of the first and second windings to generate the motor's total output. Once the motor reaches a predetermined speed, the first and second switching units open, and the third switching unit closes, enabling the power source to supply the first winding through the inverter. This setup allows the motor to operate under the inverter's control, thereby optimizing efficiency and performance.

According to another aspect of the present disclosure, a method is provided for assembling a stator assembly of a motor. The method comprises the following steps:

providing a stator core having a plurality of slots wherein each of the slots

includes a closed bottom and an open top and is divided into a first portion near the closed bottom and a second portion near the open top;

selecting a stator winding unit installed in the stator core;

providing a first switching unit,

wherein the stator winding unit comprises:

a first winding installed in the first portion of each of the slots and including a

first electrical conductor with a rectangular or square cross-section and a first rated output power under given conditions;

a second winding installed in the second portion of each of the slots and

including a second electrical conductor with a circular cross-section and a second rated output power equal to or smaller than the first rated output power under the same given conditions.

electrically connecting the first winding to a power source, and

electrically connecting the second winding to the power source via the first

switching unit.

In specific embodiments, the method may further comprise the following steps:

providing an inverter,

providing a second switching unit,

providing a third switching unit,

electrically connecting the first winding to the power source via the second switching unit,

electrically connecting the first winding to an output end of the inverter, and

electrically connecting an input end of the inverter to the power source via the third switching unit,

whereby, during the motor's startup phase, the first and second switching units are closed, and the third switching unit is opened, connecting both the first and second windings to the AC power source, combining their rated output powers to serve as the motor's total output, once the motor reaches a predetermined speed, the first and second switching units are opened, and the third switching unit is closed, leaving the AC power source connected only to the first winding via the inverter to leave the AC power source connected only to the first winding through the inverter, allowing the motor to operate under the control of the inverter.

### BRIEF DESCRIPTION OF THE DRAWINGS

Other features and advantages of the disclosure will become readily apparent to those skilled in the art from the following detailed description of the embodiments in the light of the accompanying drawings, in which:

FIG. 1 is a perspective view of a first embodiment of the present disclosure, illustrating its integration with a conventional rotor;

FIG. 2 is a cross-sectional view taken along the direction 2-2 of FIG. 1;

FIG. 3A is an enlarged schematic view of section A in FIG. 2, illustrating the arrangement of the first winding in the first portion of the slot;

FIG. 3B is another enlarged schematic view of section A in FIG. 2, illustrating the arrangement of the first winding in the first portion of the slot; and the second winding in the second portion of the slot;

FIG. 4 is a circuit diagram of the stator winding unit and the first switching unit of the first embodiment wherein the stator winding unit is connected in a wye configuration;

FIG. 5 is a circuit diagram of the stator winding unit and the first switching unit of the first embodiment according to the present disclosure, wherein the stator winding unit is connected in a delta configuration;

FIG. 6 is a block diagram illustrating the electrical connections between the stator winding unit, the first switching unit, the electrical control unit and the AC power source in the first embodiment;

FIG. 7 is an enlarged schematic view of the same position as FIG. 3, showing a second embodiment wherein the first winding installed in the second portion of the slot and the second winding installed in the first portion of the slot;

FIG. 8 is a block diagram illustrating the electrical connections of a third embodiment according to the present disclosure;

FIG. 9 is a circuit diagram of a single-phase motor in which the stator assembly is implemented according to another aspect of the present disclosure;

FIG. 10 is a block diagram illustrating the electrical connections of the stator assembly depicted in FIG. 9; and

FIG. 11 is a block diagram illustrating the electrical connections of another embodiment of the stator assembly depicted in FIG. 9.

### DETAILED DESCRIPTION

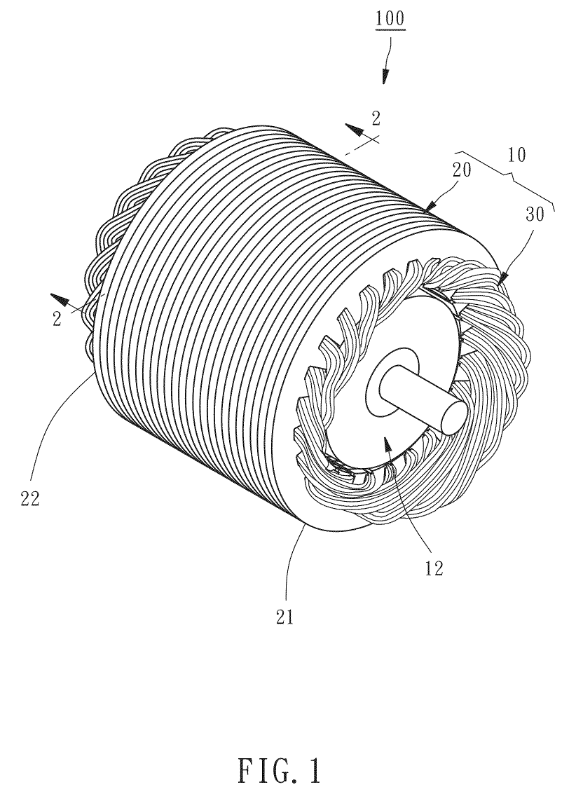

Referring firstly to FIG. 1 through FIG. 6, a first embodiment of a stator assembly according to the disclosure, designated by reference number 10, is disclosed. This stator assembly 10 is designed for application in a three-phase AC motor 100, which further includes a rotor 12 positioned within the stator assembly 10.

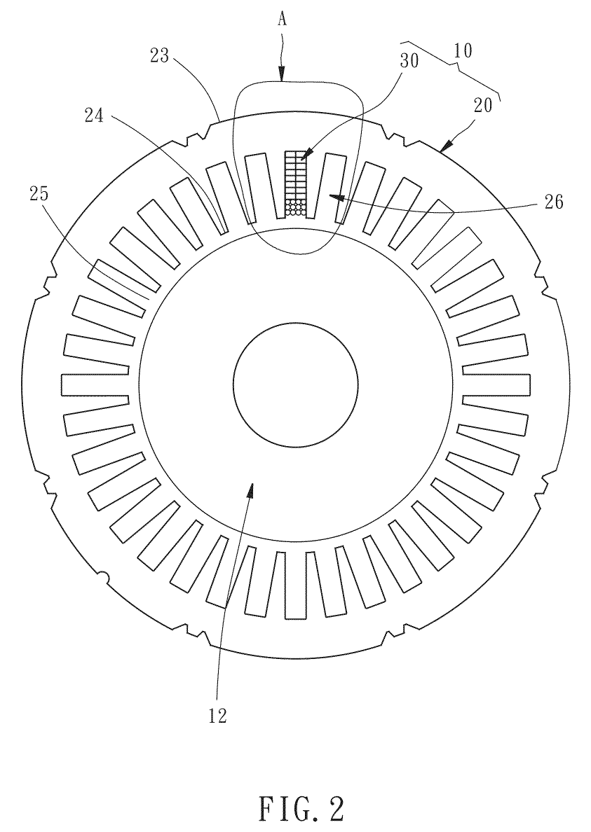

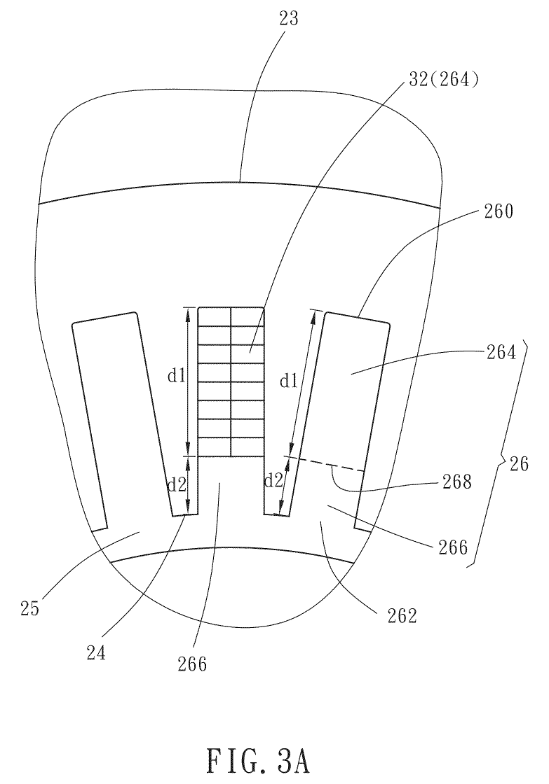

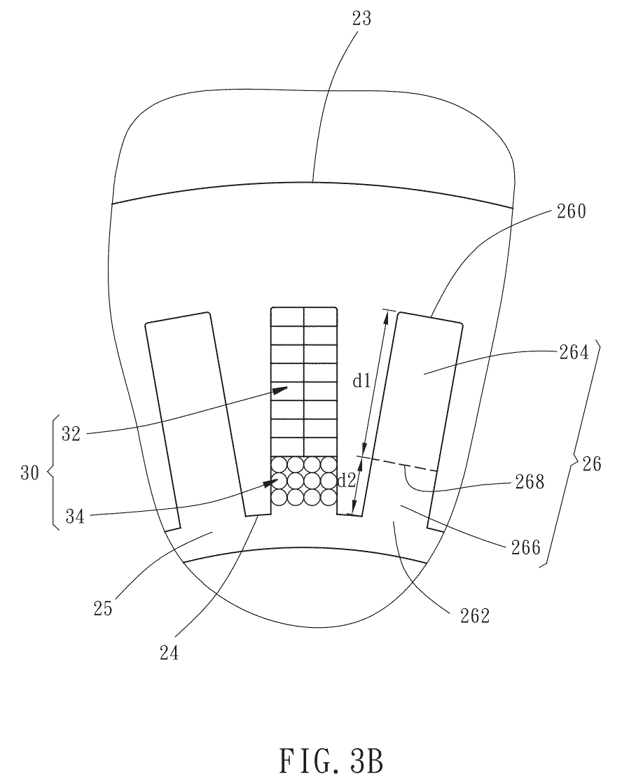

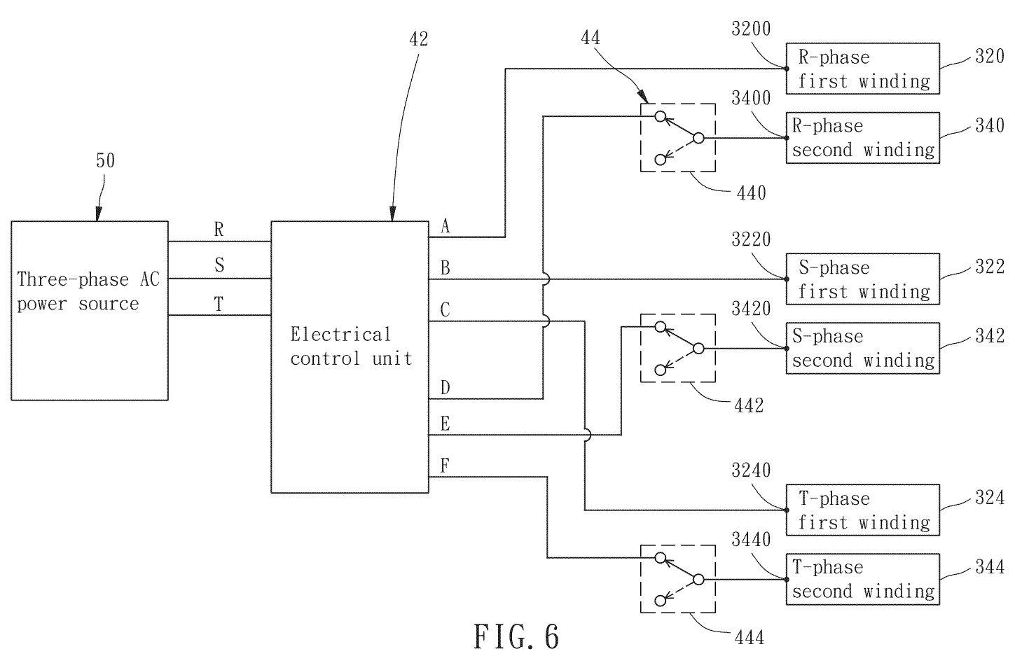

The stator assembly 10, as shown in FIG. 2, comprises a generally cylindrically-shaped stator core 20, a stator winding unit 30, an electrical control unit 42 and a first switching unit 44, as shown in FIG. 6. The stator core 20, in this embodiment, is constructed by stacking a plurality of annular silicon-steel sheets, forming a cylindrical shape. The stator core 20 includes a first and second axial ends 21, 22, an outer peripheral surface 23, an inner peripheral surface 24 and a through hole 25 and a plurality of slots 26 extending through it in the axial direction and arranged side-by-side in the circumferential direction. The through hole 25 accommodates the rotor 12. Each of the slots 26, as shown in FIG. 3A, includes a closed bottom 260 located near the outer peripheral surface 23 of the stator core 20, an open top 262 located near the inner peripheral surface 24 of the stator core 20. Furthermore, each slot 26 is conceptually divided by a virtual dividing line 268 into a first portion 264, located near the closed bottom 260 and with a depth d1, and a second portion 266, located near the open top 262 and with a depth d2. Here, d1 is greater than d2.

The stator winding unit 30 is installed within the slots 26 of the stator core 20. For clarity, as shown in FIG. 2, only one slot 26 containing a portion of the stator winding unit 30 is illustrated. More specifically, the stator winding unit 30 includes a first winding 32 installed in the first portion 264 and a second winding 34 installed in the second portion 266. The first winding 32 includes a first electrical conductor with a rectangular cross-section and a first rated output power under given conditions. As shown in FIG. 3A, during the embedding of the first winding 32, space can be reserved in the second portion 266 of the slot 26. This approach improves the filling factor within the slot 26 while simultaneously reducing the difficulty of embedding rectangular conductors. As shown in FIG. 3B, the second winding 34 includes a second electrical conductor with a circular cross-section and a second rated output power that is smaller than or equal to the first rated output power under the given conditions. Installed in the second portion 266, the second winding 34 exclusively utilizes this section of the slot 26 and is primarily designed to provide startup torque, thereby mitigating the limitations associated with circular conductors.

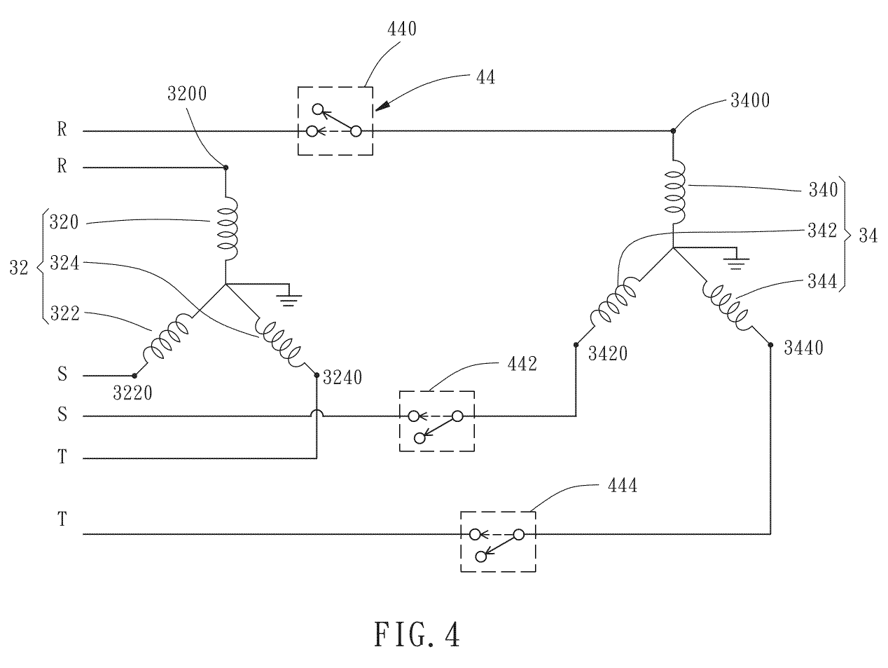

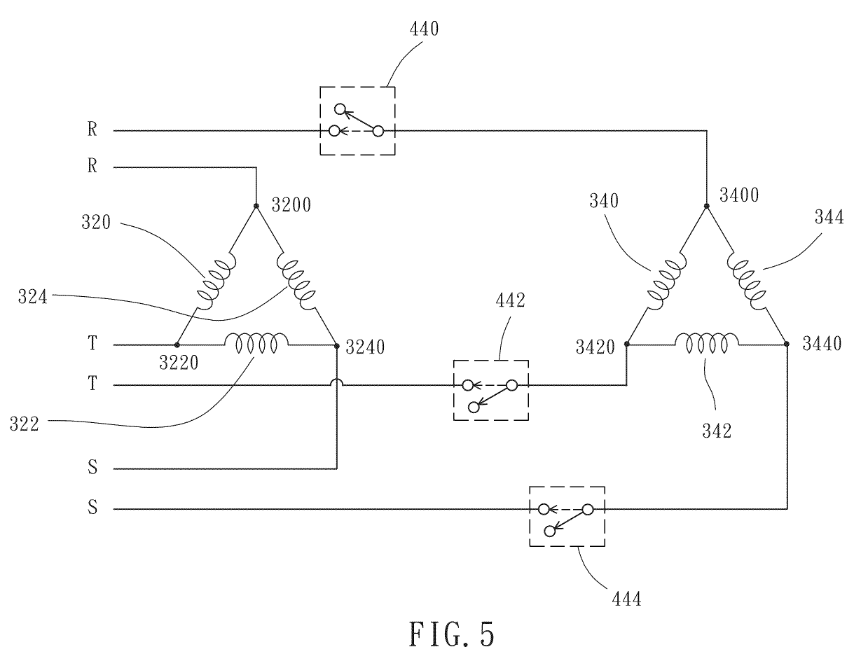

In this embodiment, as shown in FIGS. 4 and 5, the first winding 32 comprises:

a R-phase first winding 320, with a first terminal 3200,

a S-phase first winding 322, with a second terminal 3220, and

a T-phase first winding 324, with a third terminal 3240.

The R-phase first winding 320, S-phase first winding 322, and T-phase first winding 324 are connected in either a wye configuration (FIG. 4) or a delta configuration (FIG. 5).

Similarly, the second winding 34 comprises:

a R-phase second winding 340, with a first terminal 3400,

a S-phase second winding 342, with a second terminal 3420, and

a T-phase second winding 344, with a third terminal 3440.

The R-phase second winding 340, S-phase second winding 342, and T-phase second winding 344 are also connected in either a wye configuration (FIG. 4) or a delta configuration (FIG. 5).

Additionally, the first switching unit 44 includes:

a R-phase first switching unit 440,

a S-phase first switching unit 442, and

a T-phase first switching unit 444.

The electrical control unit 42 is typically implemented as a specific computer program, such as a programmable logic controller (PLC).

As shown in FIG. 6, the electrical connections are configured as follows:

Connections to the First Winding 32:

The first terminal 3200, second terminal 3220, and third terminal 3240 of the first winding 32 are connected to the electrical control unit 42 via branches A, B, and C, respectively.

The electrical control unit 42 is also connected to the R-phase, S-phase, and T-phase output terminals of the three-phase AC power source 50.

Connections to the Second Winding 34:

The first terminal 3400, second terminal 3420, and third terminal 3440 of the second winding 34 are connected to the R-phase first switching unit 440, S-phase first switching unit 442, and T-phase first switching unit 444, respectively.

These switching devices 440, 442, and 444 are, in turn, connected to the electrical control unit 42 via branches D, E, and F.

During operation, when the motor 100 starts under a predetermined load, the electrical control unit 42 initially closes the R-phase, S-phase, and T-phase first switching units 440, 442, and 444. This configuration connects both the first winding 32 and the second winding 34 to the three-phase AC power source 50, combining their rated output powers to drive the load. As the motor 100 approaches a predetermined speed, the electrical control unit 42 opens the R-phase, S-phase, and T-phase first switching units 440, 442, and 444, disconnecting the second winding 34 from the AC power source 50, leaving only the first winding 32 connected. Consequently, the motor 100 continues operating using only the rated output power of the first winding.

For example, if the rated output power of the motor is 3 HP, the rated output power of each winding (first winding 32 and second winding 34) can also be 3 HP. During startup under a predetermined load, the motor combines the output power of both windings, delivering a total of 6 HP to drive the load. As the motor reaches a predetermined speed, it transitions to operating solely with the first winding's rated output power, which is 3 HP. This ensures that the motor's output matches its rated power of 3 HP during normal operation.

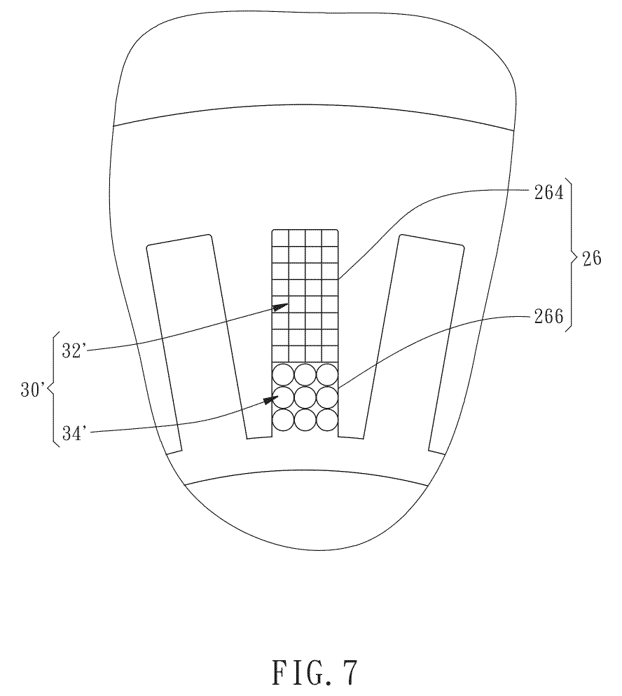

Referring to FIG. 7, in a second embodiment, the stator winding unit 30’ comprises a first winding 32’ and a second winding 34’. The first winding 32’ is constructed using a first electrical conductor with a square cross-section and is positioned within the first portion 264 of the slot 26. Conversely, the second winding 34’ is constructed using a second electrical conductor with a circular cross-section and is positioned within the second portion 266 of the slot 26.

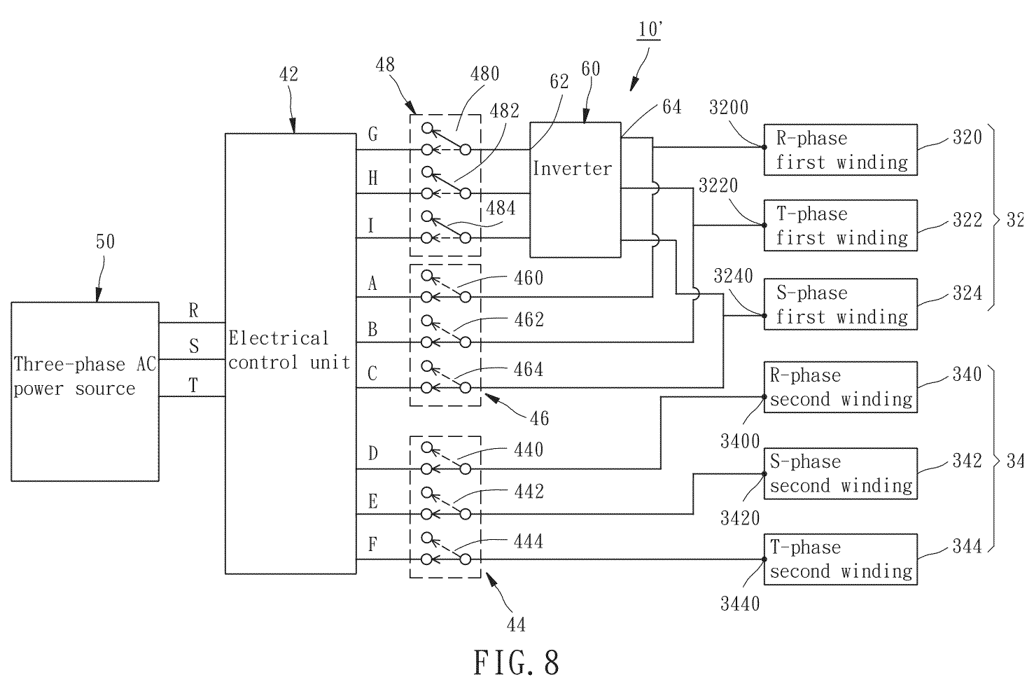

Referring to FIG. 8, a block diagram illustrates the electrical connections of a third embodiment, designated as 10’, in accordance with the present disclosure. This embodiment 10’ is designed for motor operation in conjunction with an inverter, avoiding the use of a high-power inverter during startup. Instead, it utilizes a lower-power inverter for normal operation. This design significantly reduces manufacturing costs and improves energy efficiency. The inverter, also known as a Variable Frequency Drive (VFD), ensures optimal performance while minimizing energy consumption.

The primary difference between the stator assembly 10’ and the stator assembly 10 is that the stator assembly 10’ includes additional components: an inverter 60, a second switching unit 46 comprising an R-phase second switching device 460, an S-phase second switching device 462, and a T-phase second switching device 464; and a third switching unit 48 comprising an R-phase third switching device 480, an S-phase third switching device 482, and a T-phase third switching device 484.

In this configuration, the first terminal 3200, second terminal 3220, and third terminal 3240 of the second winding 32 are connected to the R-phase second switching device 460, S-phase second switching device 462, and T-phase second switching device 464 of the second switching unit 46, respectively. The inverter 60 has input terminals 62 connected to the third switching unit 48 and output terminals 64 connected to the first terminal 3200, second terminal 3220, and third terminal 3240 of the first winding 32. Additionally, the R-phase, S-phase, and T-phase third switching devices 480, 482, and 484 of the third switching unit 48 are connected to the electrical control unit 42 via branches G, H, and I, respectively.

During the motor's startup phase, the electrical control unit 42 closes the first and second switching units 44 and 46 while keeping the third switching unit 48 open. This configuration connects both the first and second windings 32 and 34 to the AC power source 50, combining their rated output powers to drive the motor.Once the motor reaches a predetermined speed, the electrical control unit 42 switches states by opening the first and second switching units 44 and 46 and closing the third switching unit 48. In this configuration, the AC power source 50 is connected exclusively to the first winding 32 through the inverter 60, allowing the motor 100 to operate under the control of the inverter 60.

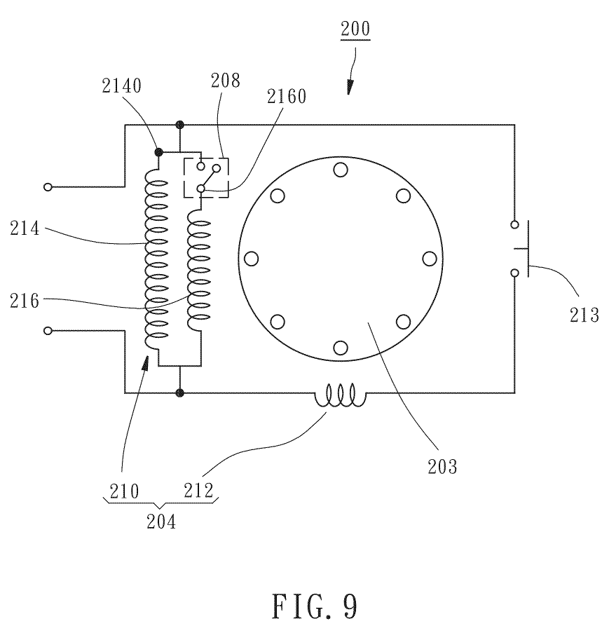

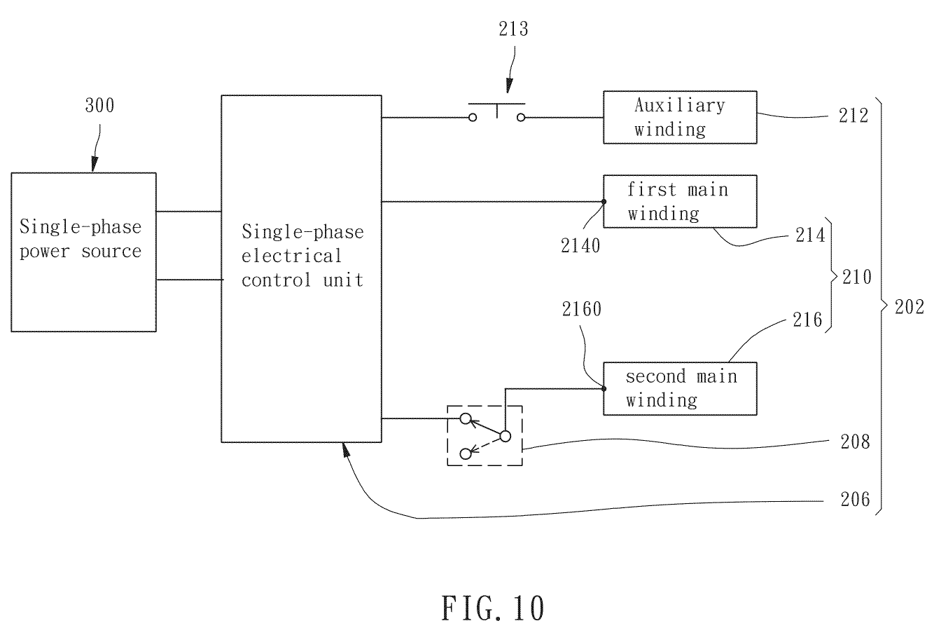

Referring to FIG. 9 and FIG. 10, FIG. 9 illustrates the circuit diagram of a single-phase motor 200, while FIG. 10 presents a block diagram detailing the electrical connections of the stator assembly 202 depicted in FIG. 9. The motor 200 includes a stator assembly 202 and a rotor 203, with the stator assembly 202 designed and implemented according to another aspect of the present disclosure.

The stator assembly 202 comprises a stator winding unit 204, a single-phase electrical control unit 206, and a first single-phase switching device 208. The stator winding unit 204 includes a main winding unit 210 and an auxiliary winding 212.

The main winding unit 210 includes a first main winding 214 and a second main winding 216. The first main winding 214 is made of an electrical conductor with a rectangular or square cross-section and is designed to deliver a first rated output power under specified conditions. The second main winding 216 is made of an electrical conductor with a circular cross-section and delivers a second rated output power under the same conditions, where the first rated output power is greater than or equal to the second rated output power.

The auxiliary winding 212 is connected to the single-phase electrical control unit 206 through a centrifugal switch 213. The first main winding 214 has a first terminal 2140 that connects directly to the single-phase electrical control unit 206. Meanwhile, the second main winding 216 has a second terminal 2160 that connects to the single-phase electrical control unit 206 via the first single-phase switching device 208. The single-phase electrical control unit 206 is further connected to a single-phase power source 300.

In operation, when the motor 200 starts under a predetermined load, the single-phase electrical control unit 206 keeps the first single-phase switching device 208 in a closed state. This configuration allows both the first main winding 214 and the second main winding 216 to connect to the single-phase power source 300, combining their rated output powers to drive the motor effectively.

As the motor 200 approaches a predetermined speed, the single-phase electrical control unit 206 transitions the first single-phase switching device 208 to an open state. In this configuration, the power source 300 connects exclusively to the first main winding 214, enabling the motor 200 to operate with only the first rated output power.

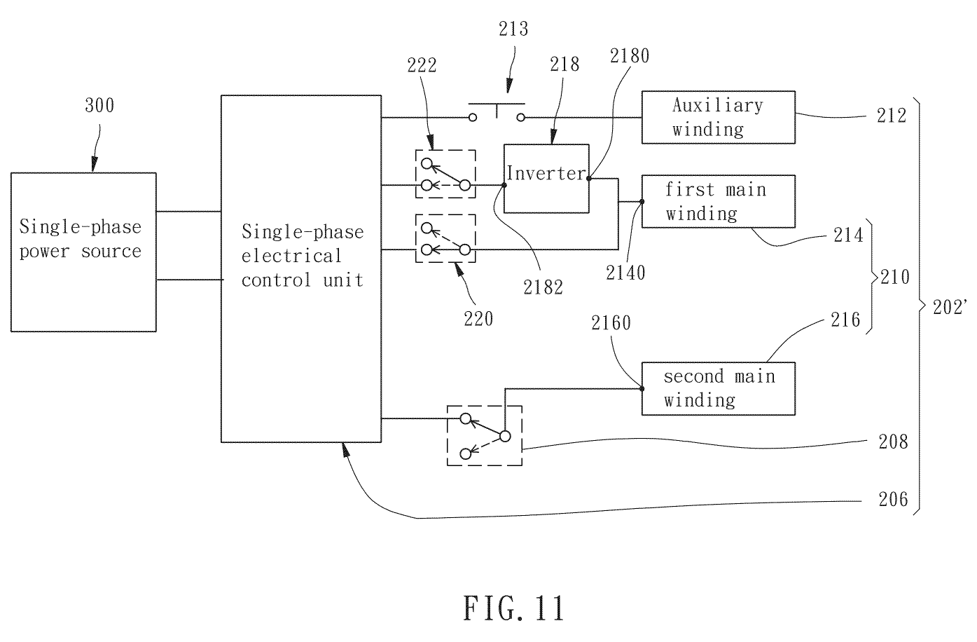

Lastly, referring to FIG. 11, a block diagram illustrates the electrical connections of another embodiment of the stator assembly shown in FIG. 9, designated as 202’.

The primary difference between the stator assembly 202’ and the stator assembly 202 is that the stator assembly 202’ incorporates additional components, including an inverter 218, a second single-phase switching device 220, and a third single-phase switching device 222. The inverter 218 has an output terminal 2180 connected to the first terminal 2140 of the first main winding 214 and an input terminal 2182 connected to the single-phase electrical control unit 206 through the third single-phase switching device 222. Furthermore, the first terminal 2140 of the first main winding 214 is also connected to the single-phase electrical control unit 206 via the second single-phase switching device 220.

During operation, when the motor 200 starts under a predetermined load, the single-phase electrical control unit 206 keeps the first and second single-phase switching devices 208 and 220 in a closed state. This configuration connects both the first and second main windings 214 and 216 to the single-phase power source 300, combining their rated output powers to drive the motor effectively. Once the motor 200 reaches a predetermined speed, the single-phase electrical control unit 206 transitions by opening the first and second switching devices 208 and 220 and closing the third single-phase switching device 222. In this state, the single-phase power source 300 connects exclusively to the first main winding 214 through the inverter 218, enabling the motor 200 to operate efficiently under the control of the inverter 218.

1. A stator assembly of a motor, comprising:
a stator core;
a stator winding unit installed in the stator core to generate kinetic energy in cooperation with a rotor of the motor;
a first switching unit;
the stator winding unit comprising:
a first winding including a first electrical conductor with a rectangular or square cross-section and a first rated output power under given conditions;
a second winding including a second electrical conductor with a circular cross-section and a second rated output power under the same conditions;
wherein the first rated output power is greater than or equal to the second rated output power, the first winding is electrically connected to a power source, while the second winding is electrically connected to the power source via the first switching unit;
whereby, during the motor's startup phase, the first switching unit is closed, connecting both the first and second windings to the power source, thereby combining their rated output powers as the motor's total output, once the motor reaches a predetermined speed, the first switching unit opens, leaving the power source connected only to the first winding, allowing the motor to operate at its first rated output power.

2. The stator assembly of a motor of claim 1, further comprising an electrical control unit having an input end connected to the power source and an output end having first branch connected to the first winding and a second branch connected the second winding via the first switching unit.

3. The stator assembly of a motor of claim 2, further comprising an inverter, a second switching unit and a third switching unit, wherein the second switching unit is connected between the first winding and the electrical control unit, the inverter has an input end connected to the electrical control unit via the third switching unit and an output end connected to the first winding, whereby, during the motor's startup phase, the first and second switching devices are closed, and the third switching unit is opened, connecting both the first and second windings to the power source via the electrical control unit to combine their rated output powers as the motor's total output; once the motor reaches a predetermined speed, the first and second switching devices are opened, and the third switching unit is closed, leaving the power source connected only to the first winding via the electrical control unit and the inverter to allow the motor to operate under the control of the inverter.

4. A stator assembly of a motor, comprising:
a stator core;
a stator winding unit installed in the stator core to generate kinetic energy in cooperation with a rotor of the motor;
a first switching unit;
the stator winding unit comprising:
a first winding including a first electrical conductor with a rectangular or square cross-section and a first rated output power under given conditions;
a second winding including a second electrical conductor with a circular cross-section and a second rated output power under the same conditions;
wherein the first rated output power is greater than or equal to the second rated output power;
wherein the first switching unit includes a first R-phase switching device, a first S-phase switching device, and a first T-phase switching device;
wherein the first winding includes a R-phase first winding electrically connecting to an AC power source, a S-phase first winding electrically connecting to the AC power source, and a T-phase first winding electrically connecting to the AC power source, the R-phase first winding, the S-phase first winding, and the T-phase first winding are connected in either a wye configuration or a delta configuration; and
wherein the second winding includes a R-phase second winding electrically connecting to the AC power source via the first R-phase switching device, a S-phase second winding electrically connecting to the AC power source via the second S-phase switching device, and a T-phase second winding electrically connecting to the AC power source via the first T-phase switching device, the R-phase second winding, the S-phase second winding and the T-phase second winding are connected in either a wye configuration or a delta configuration;
whereby, during the start-up stage of the motor, the first switching unit is closed, allowing the AC power source to connect to both the first and second windings simultaneously, providing a combined output power to the motor; as the motor approaches a predetermined speed, the first switching unit is opened, enabling the AC power source to source power only to the first winding, which outputs the first rated power externally.

5. The stator assembly of a motor of claim 4, wherein the stator core has a cylindrical shape with a plurality of slots extending through it in the axial direction and arranged side-by-side in the circumferential direction, the first winding and the second winding are installed in the slots.

6. The stator assembly of a motor of claim 5, wherein the first winding and the second winding are installed in each of the slots.

7. The stator assembly of a motor of claim 5, wherein each of the slots includes a closed bottom near an outer peripheral surface of the stator core and an open top near an inner peripheral surface of the stator core, and each of the slots is further divided into a first portion located near the closed bottom and a second portion located near the open top, the first winding is installed in the first portion and the second is installed in the second portion.

8. The stator assembly of a motor of claim 7, wherein the depth of the first portion is greater than the depth of the second portion.

9. The stator assembly of a motor of claim 4, further comprising an electrical control unit having an input end connected to the AC power source and an output end having first branches connected respectively to each phase’s first winding and second branches connected respectively to each phase’s second winding via each phase’s first switching device.

10. The stator assembly of a motor of claim 4, further comprising an inverter, a second switching unit having a second R-phase switching device, a second S-phase switching device, and a second T-phase switching device, a third switching unit having a third R-phase switching device, a third S-phase switching device, and a third T-phase switching device, wherein the R-phase first winding, the S-phase first winding, and the T-phase first winding are electrically connected to the AC power source via the R-phase second switching device, the S-phase second switching device, and the T-phase second switching device respectively, the inverter has an input end connected to the AC power source via the third R-phase switching device, the third S-phase switching device, and the third T-phase switching device respectively and an output end connected to the R-phase first winding , the S-phase first winding and the T-phase first winding respectively,
whereby, during the motor's startup phase, the first and second switching units are closed, and the third switching unit is opened, connecting both the first and second windings to the AC power source, combining their rated output powers to serve as the motor's total output; once the motor reaches a predetermined speed, the first and second switching units are opened, and the third switching unit is closed, leaving the AC power source connected only to the first winding through the inverter, allowing the motor to operate under the control of the inverter.

11. A method for assembling a stator assembly of a motor, comprising the following steps:
providing a stator core having a plurality of slots wherein each of the slots includes a closed bottom and an open top and is divided into a first portion near the closed bottom and a second portion near the open top;
selecting a stator winding unit installed in the stator core;
providing a first switching unit,
wherein the stator winding unit comprises:
a first winding installed in the first portion of each of the slots and including a first electrical conductor with a rectangular or square cross-section and a first rated output power under given conditions,
a second winding installed in the second portion of each of the slots and including a second electrical conductor with a circular cross-section and a second rated output power equal to or smaller than the first rated output power under the same given conditions,
electrically connecting the first winding to a power source, and
electrically connecting the second winding to the power source via the first switching unit.

12. The method for assembling a motor stator assembly of claim 11, wherein the depth of the first portion is greater than the depth of the second portion.

13. The method for assembling a stator assembly of a motor of claim 12,
wherein the first switching unit includes a first R-phase switching device, a first S-phase switching device, and a first T-phase switching device;
the first winding includes a R-phase first winding having a first terminal for electrically connecting to a R-phase end of a three-phase AC power source, a S-phase first winding having a second terminal for electrically connecting to a S-phase end of the three-phase AC power source, and a T-phase first winding having a third terminal for electrically connecting to a T-phase end of the three-phase AC power source, the R-phase first winding , the S-phase first winding , and the T-phase first winding are connected in either a wye configuration or a delta configuration; and
the second winding includes a R-phase second winding electrically connecting to the AC power source via the first R-phase switching device, a S-phase second winding electrically connecting to the AC power source via the first S-phase switching device, and a T-phase second winding electrically connecting to the AC power source via the first T-phase switching device, the R-phase second winding, the S-phase second winding and the T-phase second winding are connected in either a wye configuration or a delta configuration;
whereby, during the start-up stage of the motor, the first switching unit is closed, allowing the AC power source to connect to both the first and second windings simultaneously, providing a combined output power to the motor; as the motor approaches a predetermined speed, the first switching unit is opened, enabling the AC power source to source power only to the first winding, which outputs the first rated power externally.

14. The method for assembling a stator assembly of a motor of claim 13, further comprising the following steps:
providing an inverter,
providing a second switching unit having a second R-phase switching device, a second S-phase switching device, and a second T-phase switching device,
providing a third switching unit having a third R-phase switching device, a third S-phase switching device, and a third T-phase switching device,
electrically connecting the R-phase first winding, the S-phase first winding, and the T-phase first winding to the AC power source via the R-phase second switching device, the S-phase second switching device, and the T-phase second switching device respectively,
electrically connecting the R-phase first winding, the S-phase first winding, and the T-phase first winding to an output end of the inverter respectively,
electrically connecting an input end of the inverter to the AC power source via the third R-phase switching device, the third S-phase switching device, and the third T-phase switching device respectively,
whereby, during the motor's startup phase, the first and second switching units are closed, and the third switching unit is opened, connecting both the first and second windings to the AC power source, combining their rated output powers to serve as the motor's total output, once the motor reaches a predetermined speed, the first and second switching units are opened, and the third switching unit is closed, leaving the AC power source connected only to the first winding via the inverter to leave the AC power source connected only to the first winding through the inverter, allowing the motor to operate under the control of the inverter.
